(19) United States
(12) Patent Application Publication
(10) Pub. No.: US 2008/0157970 A1
(43) Pub. Date: Jul. 3, 2008

(54) Coarse and fine location for tagged items

(75) Inventors: Peter S. Single, Lane Cove (AU); Geoffrey J. Smith, Mt. Gavatt (AU)

Correspondence Address: BSTZ/G2 MICROSYSTEMS, INC., 12400 Wilshire Boulevard, Seventh Floor, Los Angeles, CA, 90025-1030, US

(73) Assignee: G2 Microsystems Pty. Ltd.

(21) Appl. No.: 11/725,046

(22) Filed: Mar. 16, 2007

Related U.S. Application Data
(60) Provisional application No. 60/785,703, filed on Mar. 23, 2006.

(51) Int. Cl. G08B 13/14; G08B 1/08

(52) U.S. Cl. 340/572.1; 340/539.13

(57) ABSTRACT

The location of an item may be determined by first determining a coarse location and then a fine location. In one example, a coarse position of a tagged item is determined using a coarse positioning system and the item's tag. A mobile unit, carrying a fine positioning system, is moved to the determined coarse position. Then, a fine position of the tagged item is determined by communicating between the fine positioning system of the moved mobile unit and the item's tag.

### CROSS-REFERENCE TO RELATED APPLICATIONS

The present application is related to provisional application Ser. No. 60/785,703, filed Mar. 23, 2006, entitled Coarse-Fine Location System, the priority of which is hereby claimed.

### BACKGROUND

1. Field

The present description relates to determining the location of a tagged item and, in particular to combining a mobile fine location determination system with a coarse location determination infrastructure in inventory tracking and maintenance applications.

2. Related Art

Location systems are currently used in inventory tracking and management systems. Existing location systems can determine the location of a person or piece of mobile equipment within a range of about 5 m for systems based on measuring the strength of received radio signals (RSSI, Received Signal Strength Indicator) and within a range of about 3 m for systems that use difference in arrival times between signals sent from different known locations (TDOA, Time Difference of Arrival). This is often sufficient to determine a room, a section, or a corridor, but no better. For many applications, the location must be known to within a range of less than 1 m. Existing systems are not able to provide this level of accuracy.

While high accuracy may theoretically be possible for a location system, limitations exist in many practical applications. Radio-based technologies often suffer from multipath signals. This is particularly true in enclosed or crowded areas, such as the warehouses in which inventory systems are typically used. TDOA, TOA (Time of Arrival), UWB (Ultra Wideband), and CSS (Chirp Spread Spectrum) technologies are all particularly susceptible to multipath errors.

A related difficulty occurs when the item to be located and the location system cannot communicate through LOS (Line of Sight). Variations in the radio landscape also limit the accuracy of location determinations. As people and objects move around and as other radio devices are turned on and off, the accuracy of the measurements required for location determination is reduced.

Many of these difficulties may be reduced using a wider signal band for TDOA, TOA or UWB location. However, in practical applications, the amount of radio spectrum allocated for location systems is limited and regulatory agencies may be unlikely to provide more.

Another way to reduce these limitation is with tags containing transmitters and receivers mounted on the building infrastructure. This is commonly done in some UWB systems, however, it requires a large number of specialized receivers to be able to perform location tasks. This requires a significant installation expense and ongoing maintenance.

### SUMMARY OF THE INVENTION

The location of an item may be determined by first determining a coarse location and then a fine location. In one example, a coarse position of a tagged item is determined using a coarse positioning system and the item's tag. A mobile unit, carrying a fine positioning system, is moved to the determined coarse position. Then, a fine position of the tagged item is determined by communicating between the fine positioning system of the moved mobile unit and the item's tag.

### BRIEF DESCRIPTION OF THE DRAWINGS

The invention may be more fully appreciated in connection with the following detailed description taken in conjunction with the accompanying drawings, in which like reference numerals refer to corresponding parts throughout the several views of the drawings, and in which:

FIG. 1 is a diagram of a context for the use of a coarse and fine location system according to an embodiment of the present invention;

FIG. 2 is a diagram of a communication protocol between a tagged item and a mobile unit according to an embodiment of the present invention;

FIG. 3 is a block diagram of a passive tag according to an embodiment of the present invention;

FIG. 4 is a block diagram of an active tag according to an embodiment of the present invention; and

FIG. 5 is a process flow diagram of locating a tagged item according to an embodiment of the present invention.

### DETAILED DESCRIPTION

Precise locations may be determined using a two-stage, coarse-fine positioning system. The coarse positioning system may be a conventional infrastructure system. Such systems typically use equipment that is fixed in position but this is not necessary to the present invention. The fine positioning system relies on a mobile locating unit, carried, for example, by a person or mounted on a vehicle. The coarse positioning system, which may be any of a variety of different standard locating systems, is used to find the item to be located and to position the mobile unit close to the item. The typical coarse positioning system may be able to place the mobile unit within 3 m, 5 m or 6 m of the item even in poor conditions.

The fine positioning system then uses a locating device carried on the mobile unit to locate the device to within better than 1 m location accuracy. The mobile unit may be any of a variety of different things or persons depending on the particular application for the system. The mobile unit, for example, may be a fork-lift, a security robot, or a member of a warehouse, shipping or hospital staff.

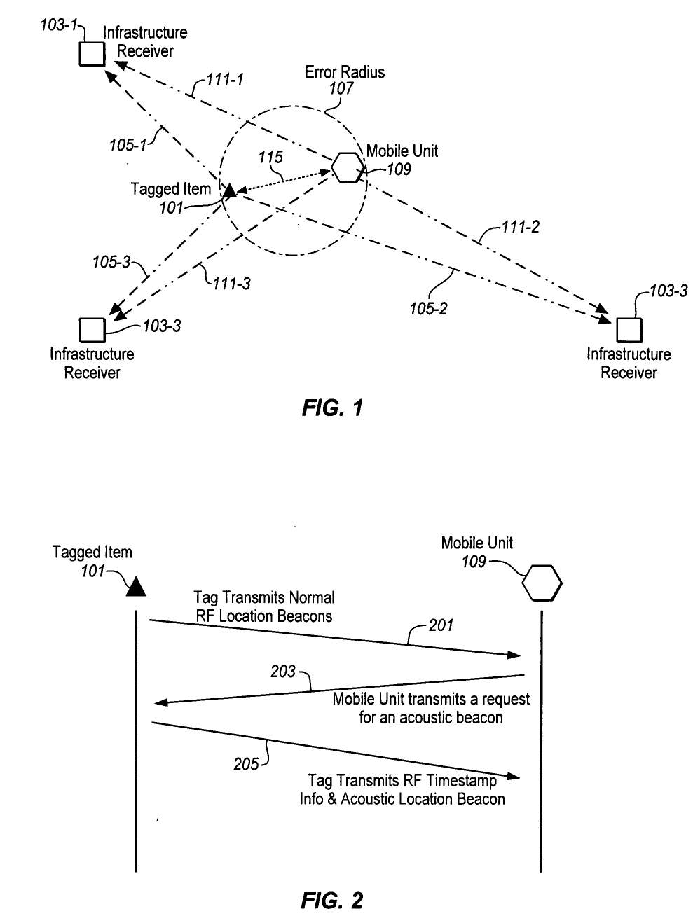

FIG. 1 shows an example context for a combined coarse-fine location system. A tagged item 101 is within range of a coarse location system 103. The tagged item is the item that is to be located. The coarse location system may be any of a variety of different kinds. In the example of FIG. 1, it includes 3 infrastructure receivers 103-1, 103-2, 103-3. These receivers receive a location beacon or signal 105 transmitted by a tag on the tagged item 101. The signal may be activated by a timer, a received command, an environmental sensor, or in some other way. It may be transmitted omni-directionally and be received along different paths by each receiver as shown by the three paths 105-1, 105-2, 105-3 between the tagged item and each receiver. Alternatively, it may be directed in some way to each receiver specifically.

The signal is typically, but not necessarily a radio signal within a predetermined wavelength band and may include identification information. While three receivers are shown, more or fewer may be used. The tag may be an active or passive RFID (Radio Frequency Identification) tag.

Alternatively, the tagged item may be located by a choke point. In some applications, a tag reader is placed at the entrances and exits to rooms, compartments, or containers. Every tag that goes through the entrance or exit is polled. This allows the location of the tagged item to be determined as being within the room, compartment, or container.

The receivers 103 use the received signal to determine the location of the tagged item to within some margin of error. This may be done using triangulation between the three receivers, or in any other way. This margin is shown as a circle 107 with an error radius 107. In typical commercial infrastructure systems, the radius of the circle is typically 5 m or so, however, it may be larger or smaller, depending on the particular application and the location system being used. If the coarse location system relies on a choke point, the circle or error may be an entire room or section. Accordingly, while shown as a circle, the circle or error may not be round.

As mentioned above, the infrastructure location system may use any one or more of a variety of different ways to determine the position of the tagged item. These may include RSSI, TDOA, TOA, AOA, and choke points, among others. Even with radio based location systems, the circle of error may not be round due to distortions and obstacles in the radio path. In the example of FIG. 1, one of the receivers 103-2 is farther from the tagged item than are the other two. This may cause the error in the determined location to be greater in the direction of the more remote receiver. The “circle of error” is used here to represent the known location of the tagged item, rather than to characterize the types of errors in the coarse location system. The distortions in the “circle of error” depend on the particular coarse location system, its environment, and how it is deployed.

Based on the information from the coarse location infrastructure location system, a mobile unit has gone to the identified location of the tagged item. In FIG. 1, the mobile unit is within the circle of error, but as far away from the tagged item as possible. In practice, the mobile unit may be anywhere in the circle, whether very far from or very close to the tagged item. The mobile unit may find the coarse location by receiving coordinates or a location, such as a room number, aisle number, etc. from the coarse location system. Alternatively, the mobile unit may be guided there by the coarse location system. In FIG. 1, the mobile unit sends a beacon 111-1, 111-2, 111-3 that is received by each infrastructure receiver 103. The receivers can then determine the coarse location of the mobile unit and send directions, corrections or some other signal (not shown) to the mobile unit to guide it toward the tagged unit.

Once the mobile unit has arrived at the approximate location of the tagged item, the mobile unit can attempt to communicate with the tagged item directly. This is shown as a two-way communication link 115 in FIG. 1. As with the infrastructure receivers, the two-way communication may be a simple backscatter RFID (Radio Frequency Identification) signal from a passive RFID tag, or it may be a more complex communication. The mobile unit may then precisely locate the tagged item, as described in more detail below. As may be understood from FIG. 1, the mobile unit is able to more accurately locate the tagged item, first because it is able to come much closer to the tagged item, and second because it is able to move. The benefits of these two features will become more clear in the description below. The mobile unit may use either one or both of these features in determining a fine location.

The infrastructure location system in FIG. 1 includes three receivers, however, there may be many more components. These receivers may be connected together directly or through other components. There may be a centralized location system that uses information from the receivers to determine the locations of items. The communications between the tagged item and the receivers may be very complex or very simple, depending on the particular application. There may also be other types of receivers or transmitters to assist the coarse location system. Similarly, the mobile unit may be carried by or worn by a person, it may be an automated device, or it may be a vehicle that is driven by a person. Many details have been omitted from FIG. 1 in order to better show the general context.

The fine location mechanism may work better if the mobile location device has some intelligence, for example if it is capable of supporting TDOA, TOA or AOA (Angle of Arrival) measurements. Alternatively, some or all of this intelligence may be in a central infrastructure that is in communication with the mobile system. In one example, the measurement system of the mobile location device provides a direction correction to the mobile unit as the unit moves in order to direct the mobile unit toward the item. This might be done either autonomously or with the help of other services within the overall location system infrastructure, either for the coarse system or the fine system.

A fine positioning or location system may be used in a wide variety of different contexts. In a conventional inventory tracking and maintenance system, it may be used, for example in a variety of different warehouse or storeroom contexts. In one example, the coarse position system may be used to locate pallets, shipping containers, or boxes to within the coarse system's accuracy level. As mentioned above, this may typically be on the order of about 5m. However, under different circumstances or with different systems, the accuracy may be significantly less or more. A forklift, forklift operator, or other mobile unit may then be directed to the location determined by the coarse positioning system. A fine location tag system mounted on the forklift and a tag on the pallet then work together to close the position accuracy to less than 1 m. In practical applications, this means that after taking the forklift to the general location of the pallet, the fine positioning system then is able to direct the forklift directly to the particular pallet desired or even a package on the pallet.

A very different possible application for the coarse-fine location system is with a record tracking system as may exist in a hospital, a large office, an agency or an archive. In one example, assume that hospital records for a particular patient have been lost but the coarse location system can place the nurse within the general location (5 m or so) of the records. The nurse or record keeper goes to this approximate area. This may mean to a particular file room or office. Then, a fine location tag system carried by or worn by the nurse and the tag mounted on the documents work together to close the several meter gap to less than 1 m. In other words, the coarse position system directs the nurse to the right office, wing or file room, then the fine location system directs the nurse directly to within an arm's reach of the right file. The same approach may also be used for valuable equipment in the hospital, a workshop, or a service facility.

Such a system may also be used in search and rescue contexts. In one such scenario. Emergency services personnel may enter a building and fire up an emergency infrastructure location system. This could be a portable system brought in by the emergency services personnel or they may use the existing infrastructure that is installed in the building. In a “person down” scenario, a person wearing a tag may be in need of help. The location system may be used to place the rescue team within a close distance of the person. The fine location tag system mounted on a rescue team member and the tag mounted on the person needing help may then work together to close the gap and allow the person to be found.

In better circumstances, it may be easier and just as quick for the rescue team member, once he is within 5 m or 6 m to call out to the person down. However, this may not always be possible or practical. First the emergency infrastructure may not be as accurate as a system that is permanently installed in a warehouse or even a hospital. This would mean that the coarse location may have an error of 12 m or 20 m. Second, the “person down” may not be able to hear or respond to another's voice. Third, the environment may make it difficult to find someone, there may be smoke, rubble, fire or other substances obscuring the view or masking sounds, or the whole scenario may be under snow, under water, or in a dark network of small rooms or caves.

The fine location system may be implemented in a variety of different ways. One approach is to use a TOA (Time of Arrival) based mechanism to give ranging. The tagged item sends or backscatters an RF (Radio Frequency) signal and the mobile unit measures its time of arrival. From this, the travel time of the signal may be determined which will provide the distance between the tagged item and the mobile device. The timing may be based on a shared clock, a response time for a poll from the mobile unit or on some other measure. The TOA mechanism may be used to determine the actual distance to the tagged item or only a relative distance. The mobile device may then move about to determine whether it is coming closer or nearer to the tagged item. By repeatedly moving and measuring the TOA or a value related to the TOA, the mobile unit, by trial and error can move toward the tagged item until the desired position accuracy is reached.

Rather than TOA, the mobile unit may use a RSSI (Received Signal Strength Indication) based mechanism or a similar type of mechanism instead. RSSI and similar measures are more accurate when the sender and receiver are in close proximity to each other. Since the mobile unit is already in or within the circle of error, the amplitude of the received signal is a more useful measure than it is for the coarse location system. RSSI falls off rapidly with distance and the SNR (Signal to Noise Ratio) is high when the two are in close proximity. As a result, close RSSI readings can be turned into distance estimates. If the characteristics of the tagged unit's sender or the mobile unit's receiver are not well known, then the RSSI may instead be used directly as a relative measure without knowing the actual distance. As with the TOA, the mobile unit may move and then measure the RSSI again. It can determine whether it is getting closer or further and with enough attempts and measurements can come to within the desired fine location accuracy.

Either approach may be combined with some way to measure the direction from which the tagged item's signal is being received. If the direction is known, then the mobile unit can move in the measured direction and come to the tagged item much more quickly than by trial and error. Alternatively, the direction and distance may be combined to compute the location of the tagged item without any further movement by the mobile unit.

The TOA or RSSI system may be coupled, for example, with an RF beam forming system to deliver Angle of Arrival (AOA) information. Using two or more antennas, or two or more receivers mounted on the mobile unit, or even two cooperating mobile units allows the system to compare the tagged item's signal as it is received by the two different antennas or receivers. In one example, the time of arrival of the two signals at the two antennas is compared. The time difference together with the distance between the two antennas allows the angle of arrival of the signal to be determined. This angle may also be based on the geometry of the antenna locations and the relative RSSI measurements.

Generally, the greater the distance between the antennas and the larger the number of antennas, the more accurately the location can be determined. A more precise location is also provided by accurately calibrating the timing, distances, and other parameters of the receiver. Depending on the application and the operating environment, the multiple antenna system may be made to deliver an approximation or a very accurate measurement. While accurate calibration and larger arrays allows the tagged item to be located more quickly, it adds to the size, complexity and cost of the receiver. Not only are more antennas required, but the measurements must be made and combined to determine the angle.

In order to increase the accuracy of the fine location system, acoustic signals may be used in addition to or instead of radio signals. While RF signals present advantages at close range in avoiding multipath, and interference, the closer range and desired accuracy make it difficult to obtain high precision using any system that relies on the travel times of an RF signal. The travel time for an RF signal to travel 5 m is only a few nanoseconds. The difference in arrival times between two antennas will be a small fraction of that. Acoustic signals, such as sound waves and other pressure waves, on the other hand travel at much slower speeds. While the speed of light is about 300,000,000 m/s, the speed of sound at normal room conditions is only about 350 m/s. Using acoustic waves instead of electromagnetic waves increases the travel time from a few nanoseconds to a few milliseconds. Inexpensive modern electronics systems are easily able to accurately measure and compare times in the millisecond range.

An acoustic fine location system may be operated in a variety of different ways. In one example, the mobile unit first arrives at the general location of the tagged item. It then sends a command to the tag. This command may be an RF command or an acoustic command. For larger sized commands, an RF transmission may be used. The tag responds by sending a location beacon or signal. This may be an acoustic beacon or an RF location beacon together with an acoustic location beacon. The two beacons may be sent at the same time or the acoustic beacon may follow after a known fixed delay.

If an RF location beacon is sent, then in the example of FIG. 1 with a an error radius of about 5 m, the mobile unit will receive the RF transmission in less than 1 μs (including processing time). The acoustic signal, on the other hand, travels at 347 m/s (25° C.). If the clock system used to measure time of arrival, angle of arrival and similar measures at the mobile unit is running at 20 ns, a common speed for small inexpensive microcontrollers, then the tagged item can be located to within 7 μm. Even with an error of 10 μs in the transmit and receive times, the tagged item can be located to within 3.5 mm. This indicates how the speed of sound, relative to the speed of light, may be used to provide an advantage in location accuracy.

If the tagged item sends an RF beacon as well as an acoustic beacon, then the time of transmission is approximately known. The actual travel time of the RF signal is trivial and can be ignored compared to the travel time of the sound wave. Alternatively, the travel time can be determined using some type of RF ranging algorithm.

Using the RF beacon for a time base, the mobile unit can range the distance to the tagged item with a one way transmission from the tagged item. One simple ranging algorithm is to simply compare the arrival time of the acoustic wave to that of the RF beacon and divide by the speed of sound. A round robin technique is not required, and the clock rates are so much faster than the speed of sound transmission that clock errors are not a significant problem. For higher accuracy, the mobile unit can measure environmental conditions such as temperature, pressure, and humidity and adjust the value used for the speed of sound accordingly.

As with the RF approaches described above, the fine location determination may be made more quickly using an angle determination. Angle of arrival can be provided by acoustic beam forming. This may be done in a manner similar to the RF beam forming approach. Multiple spaced apart microphones may be used to receive the acoustic signal and then geometry may be applied to the difference in arrival time in order to calculate the angle between the microphone array and the tagged item. Alternatively, a simple signal strength comparison algorithm may also provide suitable angle information.

FIG. 2 shows an example signal exchange that may be used in a hybrid RF and acoustic system as described above. At the start of this portion of the operation, the tagged item 101 has been located by the coarse location system. At the assigned time, or in response to the appropriate commands, with signal 101, the tag transmits its normal RF location beacons.

The mobile unit arrives in the proximity of the tagged item and sends a signal 203 that is a request for an acoustic beacon. This request may be sent with an RF or an acoustic signal. As a result, the tag with signal 205 sends an RF timestamp and an acoustic location beacon. As mentioned above, these may be sent simultaneously or according to some known interval.

If the mobile unit and the tagged item share a timing reference, then the acoustic location beacon may be sent at a time based on the shared timing reference. Such a timing reference could come from timing signals from the infrastructure receivers, from some external reference or it could be established by either the tagged item or the mobile unit for the benefit of these signals only. In the example described above, the timing reference is the RF portion of the location beacon. Based on the received beacons, the mobile unit is then able to determine a fine location of the nearby tagged item.

Other signals may be added to the example of FIG. 2. For example, the mobile unit may first send a poll or command signal to the tagged item to prompt the tag item to send its normal RF location beacon. Alternatively, the tagged item may periodically send the combined RF timestamp and acoustic location beacon based on a timer without any request or poll being received. Further modifications to FIG. 2 may also be made depending on the particular implementation.

As a further alternative, the complex electronics and signal processing systems of the mobile unit may be avoided altogether. The coarse location infrastructure may be used to make a coarse location determination of the tagged item. A person may then be sent to that location with a simple radio activation device. This device, when triggered, sends a command for the tagged item to transmit a visible or audible beacon. Once the person is placed close to the tag, the person can look for or listen for the beacon or both. People are able to perform their own approximate TOA and AOA judgments based on sounds and lights and the person should be able, in some environments, to find the tagged item quickly.

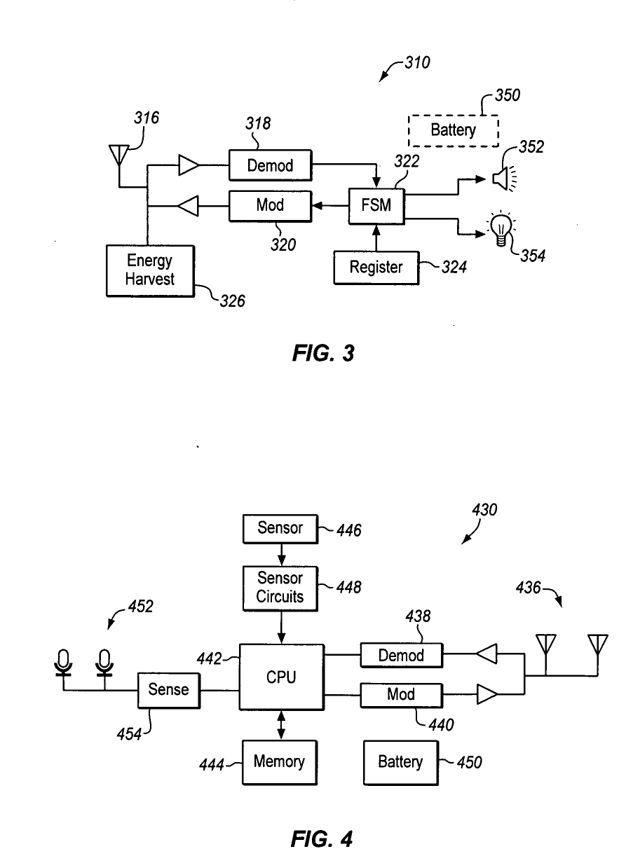

FIG. 3 shows an example of working parts that may be included in a passive RFID tag. Such a tag may be used as the tag on the tagged item 101. This tag may be in the form of an ePC Generation 1 Class 0 or 1 tag, or an ePC Generation 2 tag, or any of a number of other types of RFID tags. The ePC specifications define the physical and logical requirements for a passive-backscatter, interrogator-talks-first (ITF), RFID system using interrogators or readers and tags or labels.

The passive RFID tag 310 works in the proximity of and in conjunction with a tag reader or interrogator that may be a part of, attached to, or carried by the mobile unit 109. As described above, the tag reader includes one or more RF antennas for sending RF energy to and receiving RF energy from the tag and may also include acoustic elements.

In a standardized backscatter system, the interrogator transmits information to the passive tag by modulating an RF signal in, for example, the 860 MHz-960 MHz frequency range. The tag receives both information and operating energy from the RF signal. A passive tags is one that receives all of its operating energy from the interrogator's RF waveform.

The interrogator receives information from the passive tag by transmitting a continuous-wave (CW) RF signal to the tag. The tag responds by modulating the reflection coefficient of its antenna, thereby backscattering an information signal to the interrogator. A conventional passive RFID system is ITF, meaning that the passive tag modulates its antenna reflection coefficient with an information signal only after being directed to do so by an interrogator.

In the example of FIG. 3, the passive tag 310 includes its own antenna 316 to communicate with the tag reader. The antenna is coupled to a receive chain 318 including a demodulator for signals received from the antenna. The antenna is also coupled to a transmit chain 320 that includes a modulator for signals to be transmitted over the antenna. The receive chain and the transmit chain both include a respective gain stage and are both coupled, for example, to a FSM (Finite State Machine) 322, however other devices from direct registers to microcontrollers and processors may be used.

In a simple example, the FSM is coupled to an ID (identification) number register 324 that holds the ID number for the tag. When queried through the receive chain, the FSM will retrieve the ID number from the register, modulate it, and transmit it through the transmit chain and the antenna. Additional registers may be used to store additional values and the values may be fixed or rewriteable. Additional registers (not shown) may be used to store values from clocks, counters and environmental sensors. These values may be backscattered together with the ID number or upon a specific request.

The RF signal transmitted by the tag reader or mobile unit and received by the tag's antenna is demodulated. The subsequent bit stream may be designed to control the FSM that controls the transmit modulator. The modulator backscatters data via the antenna. This provides for two-way communication.

In one example, at least some of the tag functions (for example tag singulation) are based on whether the signal received by the antenna matches a predetermined code stored in the tag. The register 324 may, in this instance, be used to compare the incoming data stream to the tag's unique number. The result of the comparison may be used to control the tag back-scatter or be used by the tag to cause it to progress through its state transition diagram.

Singulation allows the tag reader to distinguish the backscattered signal of a tag from all of the tags around it. There are a variety of different mechanisms for singulation including tree walking, in which a tag responds based on its serial number and ALOHA, in which a tag resends its data after a random wait time.

The passive tag also has an energy harvest circuit 326 coupled to the transmit and receive chains. This circuit harvests energy received by the antenna from outside sources of RF energy including the tag reader to power the tag circuitry, including the FSM, the receiver, and the transmitter. The energy harvester may be used to eliminate any requirement for another power supply, such as an external current or a battery. This also eliminates any maintenance of the power supply or a battery allowing the tag to operate indefinitely. The tag of FIG. 1 may also be an active tag, in which case it may rely upon an optional battery 350 for some or all of its power.

As described above, the tag 310 when attached to the tagged item 101 may also be able to generate an acoustic signal. This is shown as a speaker 352 attached to the FSM 322 for control purposes. The speaker may, for example, be a piezoelectric transducer that produces a fundamental frequency in the human hearing range or in the ultrasonic to enhance propagation. The particular type of acoustic transducer may be selected based on power, frequency, environmental, and cost requirements. The tag also may have a light 354 to help guide a person to the tagged item. The light may be an LED (Light Emitting Diode) or any other type of illumination depending upon the particular application. In one example, the tag 310 operates as a passive tag until it receives a command to produce an acoustic signal or a visual signal. These devices are then powered by the battery.

FIG. 4 shows an example of working parts that may be included in an active tag, tag reader or interrogator that is mounted to or carried by the mobile unit 109. Such a tag may be used for the tagged item as well, if desired. For use on the tagged item, it may be complemented by the addition of an acoustic 352 and an optical 354 transducer as shown in FIG. 3. The illustrated active tag is self-powered and controlled by a CPU (Central Processing Unit) or microcontroller 442 executing instructions in a semiconductor memory 444.

The active tag 430 communicates with the passive tag 310 through its own antenna or antenna array 436. One or more antennas may be used. Alternatively, this may be the antenna for the tagged item 101 that communicates with the tag reader. Such a wireless communication interface may also be used to communicate with the coarse location infrastructure system or a central control station. This may be done through WiFi access points, or in any of a variety of other ways. The antenna may also be used to communicate with the infrastructure receivers, as described above, to lead the mobile unit 109 to the approximate location of the tagged item 101. As mentioned above, for angle determinations, an array of antennas may be used. The difference in arrival time or received signal strength between the two antennas may be used to determine the angle to the tagged item.

The active tag has a receive chain 438 coupled to the antenna with a demodulator and a transmit chain 440 with a modulator that are both, in this example, coupled to the CPU 442. While the antenna elements of the array may share a receive chain as shown in FIG. 4, they may instead each have a dedicated receive chain. The CPU is coupled to a memory 444 for storing data, intermediate values and programming code. The active tag may also have one or more sensors 446 coupled through driver and conversion circuitry 448 to the CPU. These sensors may include environmental sensors that may be used to calibrate the estimate of the speed of sound. They may also be used for other types of environmental monitoring. Other sensors may be used for a variety of other purposes.

A battery 450 may be used to power the active tag, however, any other type of energy storage or generation cell may be used instead of, or in addition to the battery including a solar cell, an energy harvester 326 or other power supply.

The tag may further include a microphone or array of microphones 452 to receive an acoustic signal from the tagged item. The received signal may then be converted to timing or phase differences in a sensor 454 for interpretation by the CPU 454. As with the antenna array, the time of arrival at one or more of the microphones may be used to determine distance to the tagged item. The difference in amplitude or time of arrival of a single acoustic signal at each microphone may be used to determine angular direction.

Data may be transmitted to the tag 430 from another tag, or from an infrastructure receiver, or from a wireless access point (AP). Received data may be demodulated in the receive chain 438 and presented to the CPU 442. The CPU may be used to control the modulator in the transmit chain 440 to send data back or to generate queries. The received data may be a poll, a query, values to store in the memory 444, or new programming instructions. It may also be parameters to be used in running the programs in the memory.

Depending on the programming, the active tag, acting as an active RFID tag attached to the tagged item 101, may send a periodic ID signal or respond to polling signals according to any of a variety of different protocols or routines. The position of the tag and the best connections for RF communication may be determined in a variety of different ways. In one example, a group of APs measure the RSSI (Received Signal Strength Indicator) of the tag to triangulate the position and determine the best AP for communications.

In the example of FIG. 4, the active tag is self-contained and self-sufficient. This allows the mobile unit to act independently. However, any one or more of the components of the active tag may be relocated to another location and accessed by the active tag through, for example, a radio network connection. So, for example, the active tag might make measurements of received signals and then send those signals to a networked processor for location determinations. Alternatively, the commands may be generated in the coarse position infrastructure and the replies to those commands received by the mobile unit's active tag.

The tag for the mobile unit may also have a user interface (not shown). A user interface would allow a user or operator to move the mobile unit closer to the tagged item, to read the measured location of the tagged item or to provide commands to the unit. The user interface may be a display, a touch screen, or a full display and keyboard or keypad interface. Alternatively, the tag for the mobile unit may have an electronic interface to the mobile unit. Such an interface may allow the tag to send directions, position information, or complete user interface information to the mobile unit for use in operating the mobile unit either autonomously or by a human operator.

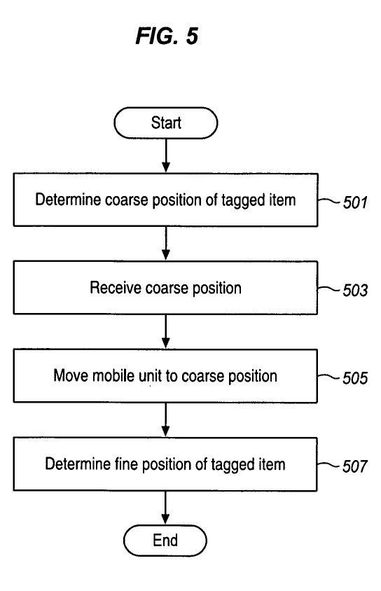

FIG. 5 is a process flow diagram indicating an operational process for the coarse-fine location determining system described above. At the start, there is a tagged item in an unknown position and a mobile unit with a fine positioning system. The tagged item is first located with a coarse positioning system as indicated at box 501. This may be done, as mentioned above, using a fixed infrastructure or with a temporary system as might be used by an emergency crew.

At box, 503, this coarse position is received by a fine positioning system. The fine positioning system is at least partially mobile and at block 505 is moved to the coarse position. As shown in FIG. 1, the coarse position is an approximate area that includes the tagged item. The size and shape of the approximate area will depend upon the capabilities of the coarse positioning system. In this example, the mobile unit is a vehicle to move at least a part of the fine positioning system. However, there may be other implementations.

At block 507, the fine positioning system determines the fine position of the tagged item. This may be done in any of a variety of different ways as described above. The fine positioning system is able to take advantage of the close range to the tagged item. This allows a higher accuracy to be obtained using approaches that would be less effective if used from a greater range.

A lesser or more complex passive transceiver structure, active transceiver structure, tag, coarse and fine positioning system, communications protocol, and supporting infrastructure may be used than those shown and described herein. Therefore, the configurations may vary from implementation to implementation depending upon numerous factors, such as price constraints, performance requirements, technological improvements, and other circumstances. Embodiments of the invention may also be applied to other types of inventory tracking and control systems and different RFID systems that use different types of transponders and protocols than those shown and described herein.

In the description above, for purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various steps. The steps of the present invention may be performed by hardware components, such as those shown in the figures, or may be embodied in machine-executable instructions, which may be used to cause general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program an agent or a computer system to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of machine-readable media suitable for storing electronic instructions.

Many of the methods and apparatus are described in their most basic form but steps may be added to or deleted from any of the methods and components may be added or removed from any of the described apparatus without departing from the basic scope of the present invention. Many further modifications and adaptations may be made. The particular embodiments are not provided to limit the invention but to illustrate it. In the description above, numerous specific details are set forth. However, it is understood that embodiments of the invention may be practiced without these specific details. For example, well-known equivalent circuits, components, assemblies and configurations may be substituted in place of those described herein, and similarly, well-known equivalent techniques, processes, and protocols may be substituted in place of the particular techniques described. In other instances, well-known circuits, structures and techniques have not been shown in detail to avoid obscuring the understanding of this description.

While the embodiments of the invention have been described in terms of several examples, those skilled in the art may recognize that the invention is not limited to the embodiments described, but may be practiced with modification and alteration within the spirit and scope of the appended claims. The description is thus to be regarded as illustrative instead of limiting.

What is claimed is:

1. A method comprising:
receiving a coarse position of a tagged item determined using a coarse positioning system and the item's tag;
moving a mobile unit to the determined coarse position, the mobile unit carrying a fine positioning system;
determining a fine position of the tagged item by communicating between the fine positioning system of the moved mobile unit and the item's tag.

2. The method of claim 1, wherein the item's tag is a passive RFID tag.

3. The method of claim 1, wherein determining the fine position comprises receiving a location beacon from the item's tag and measuring the strength of the received signal.

4. The method of claim 1, wherein determining the fine position comprises receiving a location beacon from the item's tag and measuring the time of arrival of the received signal.

5. The method of claim 4, wherein the location beacon comprises an acoustic signal.

6. The method of claim 1, wherein the time of arrival is determined based on a shared timing reference.

7. The method of claim 6, wherein the shared timing reference is based on a signal sent from the item's tag to the fine positioning system.

8. The method of claim 4, wherein receiving the location beacon comprises receiving the beacon at two spaced apart locations and determining an angle of arrival of the received signal by comparing the signal at the two locations.

9. The method of claim 8, further comprising determining the coarse position of the tagged item using a fixed coarse positioning infrastructure.

10. The method of claim 9, wherein receiving the coarse position comprises receiving the coarse position from the fixed coarse positioning infrastructure at the fine positioning system.

11. A machine-readable medium having instructions stored thereon that when operated on by a machine, cause the machine to perform operations comprising:
receiving a coarse position of a tagged item determined using a coarse positioning system and the item's tag;
moving a mobile unit to the determined coarse position, the mobile unit carrying a fine positioning system;
determining a fine position of the tagged item by communicating between the fine positioning system of the moved mobile unit and the item's tag.

12. The method of claim 11, wherein determining the fine position comprises receiving a location beacon from the mobile's tag and measuring the time of arrival of the received signal compared to a timing reference shared by the mobile unit and the item's tag.

13. The method of claim 11, wherein determining the fine position comprises comparing the location beacon received two spaced apart locations to each other and to a timing reference to determine an angle of arrival of the location beacon and a distance of the location beacon.

14. A mobile location system comprising:
a coarse position communications interface to receive a coarse position of an item having a tag;
a fine position communications interface to communicate between the mobile location system and the item's tag;
a fine positioning system to determine a fine position of the tagged item using the fine communications interface.

15. The apparatus of claim 14, wherein the fine positioning system receives a location beacon from the item's tag and measures the strength of the received signal.

16. The apparatus of claim 14, wherein the fine position communications interface comprises a microphone.

17. The apparatus of claim 16, wherein the fine position communications interface comprises an array of microphones to receiving an acoustic location beacon at two spaced apart locations and wherein the fine positioning system determines an angle of arrival of the received signal by comparing the received signal at the two locations.

18. The apparatus of claim 16 wherein the fine positioning system comprises a radio frequency antenna to receive a timing reference from the item's tag.

19. The apparatus of claim 14, wherein the fine position communications interface comprises an array of radio frequency antennas to measure distance and angle between the antennas and the item's tag using location beacons received from the item's tag.

20. The apparatus of claim 14, further comprising a microphone to receive an acoustic location beacon from the item's tag and environmental sensors coupled to the fine positioning system to provide measurements for use in estimating a speed of sound, wherein the fine positioning system uses an estimate of the speed of sound to determine the fine position based on the acoustic location beacon from the microphone.
